(19) United States
(12) Patent Application Publication
(10) Pub. No.: US 2008/0267851 A1
(43) Pub. Date: Oct. 30, 2008

(54) High Whiteness Metakaolin and High Whiteness Fully Calcined Kaolin

(76) Inventors: Edward J. Sare, Macon, GA (US); Tommy L. Adkins, Cochran, GA (US); Stephen C. Raper, Byron, GA (US); Julie Figlar, Clemmons, NC (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/567,433

(22) PCT Filed: Jul. 15, 2004
(86) PCT No.: PCT/US04/18934

§ 371 Date: Apr. 16, 2007

Related U.S. Application Data
(60) Provisional application No. 60/493,808, filed on Aug. 11, 2003.

(51) Int. Cl. C01B 33/26; C08K 3/34

(52) U.S. Cl. 423/327.1; 524/447

(57) ABSTRACT

The present invention relates to calcined kaolins having optimal whiteness and brightness properties. The calcined kaolins can comprise metakaolin, fully calcined kaolin, or flash calcined kaolin. The kaolin can be calcined from hydrous kaolin that has been subjected to enhanced magnetic separation. The resulting calcined kaolin can have a whiteness defined by a Hunter lab coordinate L value of at least about (96). The calcined kaolin can also have a brightness of at least about (90), as measured by a Technibrite TB-1C instrument. The present invention also relates to methods of preparing calcined kaolins. The present invention also relates to paints, polymers, coatings, ceramics, paper, and cementitious products comprising these calcined kaolins.

This application claims priority to U.S. Provisional Patent Application No. 60/493,808, filed Aug. 11, 2003.

The present invention relates to calcined kaolin having a high whiteness and brightness. The calcined kaolin can be metakaolin, fully calcined kaolin, or flash calcined kaolin. These kaolins can have many uses, including as fillers or extenders in paint and coating compositions. More generally, the inventive products may be used wherever calcined kaolins are used.

Calcined kaolin is generated from hydrous kaolin. Particulate kaolins occur naturally in the hydrous form and exist as crystalline structures containing hydroxyl functionality. Particulate kaolins may be converted to a calcined form by thermal processes. Such processes cause the particulate kaolin to dehydroxylate. During calcination, the hydrous kaolin converts from a crystalline to an amorphous form. Further, during calcination, aggregation typically occurs.

Calcined kaolins can be used to improve the opacity of a pigment and find widespread use as pigments in paints, plastics, rubbers, sealants, and as raw materials for ceramics, cementitious products and other application compositions. For example, calcined kaolins can be used as flatting (or matting) agents in paints and coatings. They can help control the gloss and sheen of the surfaces of a final, dried paint film. Regarding optical paint film properties, they can impart opacity, whiteness, and other desirable properties. They can also serve as extenders by partial replacement of titanium dioxide and other more expensive pigments with minimal loss of whiteness or opacity.

Crude hydrous kaolin, however, often has contaminants that can discolor the mineral. These contaminants can be, for example, iron- and/or titanium-based impurities. This discoloration can carry over to the resulting calcined kaolin causing a reduced brightness and/or whiteness. Typical processes for purifying particulate minerals include froth flotation treatment, selective flocculation, or magnetic separation in the case where the impurity is magnetically active. There remains a need, however, for calcined kaolin pigments prepared from purified hydrous kaolin having desired optical properties, such as, high whiteness and brightness.

One aspect of the present invention provides a method of making a calcined kaolin, comprising:

(a) providing a hydrous kaolin;

(b) subjecting the hydrous kaolin to enhanced magnetic separation;

(c) heating the hydrous kaolin to a temperature ranging from about 500° C. to about 1200° C. for a time sufficient to at least partially dehydroxylate the hydrous kaolin; and

(d) obtaining a calcined kaolin having a whiteness defined by a Hunter lab coordinate L value of at least about 96.

Another aspect of the present invention provides a composition comprising a kaolin calcined from an enhanced, magnetically separated hydrous kaolin, wherein the calcined kaolin, when dry, has a whiteness defined by a Hunter lab coordinate L value of at least about 96.

Another aspect of the present invention provides a composition comprising a metakaolin having a whiteness defined by a Hunter lab coordinate L value of at least about 96.

One aspect of the present invention provides calcined kaolin having high whiteness and brightness. Pigment color can be assessed with Hunter L* a* b* coordinates, where L* is a measure of the whiteness of the pigment. Alternatively, whiteness can be measured by the ASTM-E-313 standard method. Brightness can be measured by a Technibrite TB-1C instrument or a Hunter UltraScan XE instrument.

Another aspect of the invention provides a calcined kaolin having a whiteness defined by a Hunter lab coordinate L value of at least about 96, such as an L value of at least about 97, an L value of at least about 97.5, or an L value of at least about 98. In another aspect, the invention provides a calcined kaolin having a brightness of at least about 90, such as a brightness of at least about 91, as measured by a Technibrite TB-1C instrument. The calcined kaolin can be obtained by subjecting a hydrous kaolin to enhanced magnetic separation, followed by calcining.

“Calcined kaolin” as used herein refers to a kaolin that has been converted from the corresponding (naturally occurring) hydrous kaolin to the dehydroxylated form by thermal methods. Calcination changes, among other properties, the kaolin structure from crystalline to amorphous. Calcination is effected by heat-treating coarse or fine hydrous kaolin in any known manner, e.g., at temperatures ranging from about 500° C. to about 1200° C., such as temperatures ranging from about 800° C. to about 12000C, from about 800° C. to about 950° C., from about 900° C. to about 1200° C., from about 700° C. to about 900° C., from about 800° C. to about 850° C. In another embodiment, the hydrous kaolin can be heated at a temperature of about 900° C., or of at least about 900° C.

The degree to which hydrous kaolin undergoes changes in crystalline form can depend upon the amount of heat subjected to the hydrous kaolin. Initially, dehydroxylation of the hydrous kaolin can occur upon exposure to heat. At temperatures below a maximum of about 850-900° C., the product is often considered to be virtually dehydroxylated, with the resultant amorphous structure commonly referred to as a metakaolin. Frequently, calcination at this temperature is referred to as “partial calcination,” and the product may also be referred to as “partially calcined kaolin.” Further heating to temperatures above about 900-950° C. can result in further structural changes, such as densification. Calcination at these higher temperatures is commonly referred to as “full calcination,” and the product is commonly referred to as “fully calcined kaolin.”

Additional calcination may cause formation of mullite. Mullite concentrations ranging from about 2% to about 40% by weight, relative to the total weight of the composition according to the invention may be useful in some end-use applications, such as ceramic catalyst substrates, e.g., cordierite substrates. In other embodiments, mullite may be present in the composition in an amount ranging from greater than about 2%, greater than about 5%, or greater than about 8%, by weight relative to the total weight of the composition.

Accordingly, “calcined” (or “calcination”), as used in herein, may encompass any degree of calcination, including partial (meta), full, and/or flash calcination.

Effective calcining procedures include, but are not limited to, soak calcining and flash calcining. In soak calcining, a hydrous kaolin is heat treated at temperatures ranging from about 500° C. to about 1200° C., such as temperatures ranging from about 800° C. to about 1200° C., or temperatures having a maximum of about 850-900° C., or temperatures of at least about 900-950° C., as described herein, for a period of time (e.g., from at least several minutes to 5 or more hours) sufficient to dehydroxylate the kaolin. In flash calcining, a hydrous kaolin is heated rapidly for a period of less than about 1 second, typically less than about 0.5 second at the temperatures described herein.

The furnace, kiln, or other heating apparatus used to effect calcining of the hydrous kaolin may be of any known kind. Known devices suitable for carrying out soak calcining include high temperature ovens, rotary kilns, and vertical kilns. Known devices for effecting flash calcining include toroidal fluid flow heating devices, such as those described in WO 99/24360, the disclosure of which is incorporated by reference herein.

Another aspect of the present invention provides a method of making a calcined kaolin, comprising:

(a) providing a hydrous kaolin;

(b) subjecting the hydrous kaolin to enhanced magnetic separation;

(c) heating the hydrous kaolin to a temperature ranging from about 500° C. to about 1200° C. for a time sufficient to at least partially dehydroxylate the hydrous kaolin; and

(d) obtaining a calcined kaolin having a whiteness defined by a Hunter lab coordinate L value of at least about 96, such as an L value of at least about 97, at least about 97.5, or at least about 98. In one embodiment, the calcined kaolin has a brightness of at least about 90, such as a brightness of at least about 91, as measured by a Technibrite TB-1C instrument.

“Heating the hydrous kaolin” refers to any of the calcination processes discussed above. Heating to a temperature can comprise heating the hydrous kaolin at one temperature only, at two or more different temperatures, or over a range of temperatures. The heating can occur for a time to partially or fully calcine or dehydroxylate the hydrous kaolin depending on the heating time and temperature. For example, in one embodiment, the heating can be carried out for a time sufficient to partially calcine the hydrous kaolin. In another embodiment, the heating can be carried out for a time sufficient to fully calcine the hydrous kaolin.

In one embodiment, the heating in (c) comprises heating the hydrous kaolin at a temperature ranging from about 700° C. to about 900° C.

In another embodiment, the heating in (c) comprises heating the hydrous kaolin at a temperature ranging from about 800° C. to about 850° C.

In another embodiment, the heating in (c) comprises heating the hydrous kaolin at a temperature of at least about 900° C., and the calcined kaolin in (d) has a Hunter lab coordinate L value of at least about 97, such as an L value of at least about 97.5.

In another embodiment, the heating in (c) comprises heating the hydrous kaolin at a temperature of at least about 900° C., and the calcined kaolin in (d) has a Hunter lab coordinate L value of at least about 98.

The hydrous kaolin to be treated by enhanced magnetic separation may be purchased commercially. Alternatively, the hydrous kaolin can be obtained by refining a naturally occurring kaolin. Exemplary naturally occurring kaolins include those obtained from Brazil, such as from the Rio Capim area, Australia, the U.S., such as Georgia, the United Kingdom, and China.

Prior to calcining, the hydrous kaolin can be subjected to magnetic separation. In performing magnetic separation, the particulate kaolin is passed through a steel matrix that is exposed to a high intensity magnetic field. The magnetic field effects a gradient across the matrix. Because magnetic particles respond to the magnetic gradient, the magnetic particles are selectively separated from non-magnetic particles, i.e., the non-magnetic particles, such as kaolin, pass through the matrix while the magnetically active particles are retained. The magnetic separation can be improved by magnetizing a non-magnetically active material, such that the non-magnetic material is selectively separated, alternatively referred to herein as enhanced magnetic separation. Non-magnetic particles, or weakly magnetic materials, such as ferro-titanates, or other naturally occurring color bodies associated with kaolin, can be magnetized by the addition of a magnet enhancer reagent. A method of using a magnet enhancer reagent is described in U.S. Pat. No. 6,006,920, the entire disclosure of which is herein incorporated by reference.

According to one embodiment, a magnet enhancer reagent can be added to the kaolin to magnetize it and allow its enhanced removal by magnetic separation. In one embodiment, a magnet enhancer reagent is a composition comprising an aqueous solution of at least one magnetic oxide. In another embodiment, the magnet enhancer reagent further comprises at least one surface active agent, to either effect or enhance the attachment between the kaolin and the at least one magnetic oxide. The at least one surface active agent can be a surfactant or blend of surfactants. The magnet enhancer reagent can comprise the at least one magnetic oxide coated with the at least one surface active agent.

Exemplary magnet enhancer reagents include those metal oxides represented generally by the formula MₓO_{y}, wherein M is at least one metal, and x and y have values depending on the charge on the at least one metal. MₓO_{y} can represent a single metal oxide or a mixed metal oxide, i.e., a metal oxide having two or more different metal types or different metal charges, such as an oxide having a formula represented by MₓM′_{x′}O_{y}. Representative metals include Fe, Ni, Co, Mn, and Nb. Exemplary magnetic oxides can include, for example, iron oxides, cobalt oxides, nickel oxides, and any metal combination such as ferroso-ferric oxides, cobalt ferric oxide (CoFe₂O₄), NiFe₂O₄. Additional suitable magnetic oxides are described in U.S. Pat. No. 4,906,382 (Hwang), U.S. Pat. No. 4,834,898 (Hwang), U.S. Pat. No. 4,125,460 (Nott et al.), U.S. Pat. No. 4,078,004 (Nott et al.), the entire disclosure of which is herein incorporated by reference.

The surface active agent increases the affinity of association between the magnetic oxide and the non-magnetic material, such as the hydrous kaolin. In one embodiment, the at least one surface active agent includes those molecules exhibiting a long hydrophobic tail and a cloud point above 65° C. In another embodiment, the at least one surface active agent has a relatively low Hydrophobic-Lithophobic Balance (HLB) value, such as 10 or less, 9 or less, 8 or less, 7 or less, 6 or less, or 5 or less, where HLB equals the ratio of weight percentages of hydrophilic to hydrophobic groups in the molecule. Exemplary surface active agents include those listed in U.S. Pat. No. 5,527,426 (Marwah et al.).

Exemplary magnet enhancer reagents include certain Nalco products commercially available as or 95DM144 or 9868 (Ondeo-Nalco Chemical Co. Naperville, Ill.).

In one embodiment, the surface active agent is present in the magnet enhancer reagent in an amount of about 5% activity, i.e. about 5% solids concentration of the magnetic metal oxide. At about 5% activity, the magnet enhancer reagent can be present in an amount ranging from about 0.5 lb/ton kaolin to about 7.5 lb/ton kaolin, such as amounts ranging from about 1.0 to about 5.0 lb/ton kaolin, from about 1.5 to about 4.0 lb/ton kaolin, or from about 2.0 to about 3.5 lb/ton kaolin.

In one embodiment, the kaolin is subjected to the magnetic separation as a slurry or suspension, such as an aqueous slurry, containing the magnet enhancer reagent. Prior to the magnetic separation, the kaolin slurry can be subjected to high shear conditions, i.e., the slurry is conditioned. The high shear can be achieved with any type of rotor device that can maintain a rotor blade tip speed of at least about 50 feet per second, such as a rotor tip speed ranging from about 50 to about 200 feet per second, or a rotor tip speed ranging from about 125 to about 150 feet per second. Appropriate rotor devices include a rotor-stator type mill, e.g., a rotor-stator mill manufactured by Kady International (Scarborough, Ma.) (a “Kady mill”) and a rotor-stator mill manufactured by Impex (Milledgeville, Ga.) (an “Impex mill”); a blade-type high shear mill, such as a Cowles blade (Morehouse Industries, Inc., Fullerton, Calif.); and a high shear media mill, such as a sand grinder.

In one aspect, the magnet enhancer reagent is shear-stable when subjected to a rotor device that can maintain a rotor blade tip speed of at least about 50 ft/s, or any of the rotor blade tips speeds described herein.

The kaolin slurry can be conditioned for a time sufficient to enhance the subsequent magnetic separation step, so long as no adverse effects on the kaolin quality are incurred. Conditioning times can vary according to the device used to impart the shear. Conditioning can be performed for any suitable time period greater than 0 seconds. For example, for conditioning with a Kady mill, the slip can be conditioned for about 1 minute to about 10 minutes, and a typical range can be from about 2 minutes to about 8 minutes, from about 3 minutes to about 6 minutes or from about 4 minutes to about 5 minutes. These typical times can be applied to other shearing devices based upon the relative shear imparted by those devices as compared to the Kady mill, with which application to other devices one of skill in the art is familiar.

In one embodiment, the enhanced magnetic separation comprises passing the kaolin slurry containing the magnet enhancer reagent through a high intensity magnetic separator. The magnetic separator may comprise a stainless steel matrix having an open structure, e.g., stainless steel wool, stainless steel balls, nails, tacks, etc. The matrix is subjected to a magnetic field to establish a magnetic gradient across the matrix. In one embodiment, the kaolin is subjected to a high magnetic field, such as a value of at least about 0.5 kilogauss.

The kaolin can be blunged and/or degritted prior to the enhanced magnetic separation by methods well known to one of ordinary skill in the art. In addition to the enhanced magnetic separation, the hydrous kaolin can be subjected to one or more other well known beneficiation steps to remove undesirable impurities. For example, the refined kaolin slurry may be ozoned, leached (bleached), subjected to froth flotation, subjected to selective flocculation, and/or filtered. In one embodiment, the hydrous kaolin can be subjected to at least one beneficiation process prior to (c), i.e., prior to heating the hydrous kaolin to a temperature to at least partially dehydroxylate the hydrous kaolin.

Alternatively, the aqueous suspension of hydrous kaolin may be subjected to a froth flotation treatment operation prior to enhanced magnetic separation to remove titanium containing impurities in the froth. In a more specific example, the slurry can be conditioned with an oleic acid to coat the air bubbles produced in the float cells. The titania minerals adhere to the air bubbles and are floated out of the kaolin slurry. An example of such a flotation process is described in U.S. Pat. No. 3,450,257, to Cundy, which is herein incorporated by reference.

Also optionally, the hydrous kaolin can be subjected to a selective flocculation process prior to magnetic separation, in which the impurities are flocced out of suspension while the hydrous kaolin remains in suspension. In one example, a high molecular weight anionic polymer having a molecular weight in excess of one million, or a molecular weight in the range of about 10 to about 15 million can be used. The anionic polymer can be a copolymer of a polyacrylamide. The kaolin may then be acid flocculated and dried, or may be redispersed in a makedown tank and alternately spray dried. Details of a particular selective flocculation process can be found in U.S. Pat. No. 4,227,920, to Chapman and Anderson. U.S. Pat. No. 5,685,900 to Yuan et al., which includes ozonation.

The calcined kaolin composition of the present invention can be used for a variety of applications where increased opacity, brightness, whiteness or sheen/gloss control are desired. For example, the calcined kaolin products of the invention can be used in industrial coating or architectural paint compositions in which any one of these characteristics are desired. Products of the invention may also be useful wherever kaolins are used, such as in making filled plastics, rubbers, sealants, and cables, or they may be used in the manufacture of ceramic products, cementitious products, and paper products. The products of the inventions can also be used as coatings for coating cementitious products or paper, e.g. paper coatings.

Paint compositions comprising the calcined kaolin may additionally comprise at least one additional ingredient chosen from a polymeric binder, a primary pigment such as titanium dioxide, a secondary pigment such as calcium carbonate, silica, nephaline syenite, feldspar, dolomite, diatomaceous earth, and flux-calcined diatomaceous earth. For water-based versions of such paint compositions, any water-dispersible binder, such as polyvinyl alcohol (PVA) and acrylics may be used. Paint compositions of the present invention may also comprise other conventional additives, including, but not limited to, surfactants, thickeners, defoamers, wetting agents, dispersants, solvents, and coalescents.

The present invention can be used in the production of all paper grades, from ultra lightweight coated paper to coated or filled board. Paper and paperboard products can comprise a coating, which can improve the brightness and opacity of the finished paper or board.

The inventive products can also serve as extenders, allowing the partial replacement of expensive titanium dioxide pigments without unacceptable loss of opacity or tint strength. The extender material can be used in paper, polymers, paints and the like or as a coating pigment or color ingredient for coating of paper, paper board, plastic papers and the like.

Paper coatings according to the present invention can include, in addition to the calcined kaolin as described above, materials generally used in the production of paper coatings and paper fillers. The compositions can include a binder and a pigment, such as TiO₂. The coatings according to the present invention may optionally include other additives, including, but not limited to, dispersants, cross linkers, water retention aids, viscosity modifiers or thickeners, lubricity or calendering aids, antifoamers/defoamers, gloss-ink hold-out additives, dry or wet rub improvement or abrasion resistance additives, dry or wet pick improvement additives, optical brightening agents or fluorescent whitening agents, dyes, biocides, leveling or evening aids, grease or oil resistance additives, water resistance additives and/or insolubilisers.

Any art recognized binder may be used in the present invention. Exemplary binders include, but are not limited to, adhesives derived from natural starch obtained from a known plant source, for example, wheat, maize, potato or tapioca; synthetic binders, including styrene butadiene, acrylic latex, vinyl acetate latex, or styrene acrylic; casein; polyvinyl alcohol; polyvinyl acetate; or mixtures thereof.

Paper coatings have very different binder levels depending upon the type of printing to be used with the coated paper product. Appropriate binder levels based upon the desired end product would be readily apparent to the skilled artisan. Binder levels are controlled to allow the surfaces to receive ink without disruption. The latex binder levels for paper coatings generally range from about 3% to about 30%. In one embodiment according to the present invention, the binder is present in the paper coating in an amount of from about 3% to about 10%. In another embodiment according to the present invention, the binder is present in the coating in an amount ranging from about 10% to about 30% by weight.

The calcined kaolin described herein can be used in other products, such as cementitious products. Cementitious products include concrete, cement, and plaster.

Other applications for the calcined kaolin include ceramics, plastics, polymers, paper coatings, fillers, and filled papers.

The invention will be further clarified by the following non-limiting examples, which are intended to be purely exemplary of the invention.

### EXAMPLES

### Example 1

In this Example, crude hydrous kaolin was subjected to magnetic separation in a method similar to that described in U.S. Pat. No. 6,006,920.

Crude hydrous kaolin was blunged in water as a blend of 75% coarse Cretaceous crude and 25% fine tertiary crude. This blend was blunged to about 42% solids at pH=9.2 using a dispersant blend of 5 parts sodium silicate to 1 part sodium hydroxide. After degritting this crude through a Dorr-Cone, sandbox and 100 mesh screen, the crude was fractionated on a Bird Machine Co. (South Walpole, Mass.) centrifuge to obtain a fine fraction of 92% less than two microns as measured on a Sedigraph 5100 (Micromeritics, Norcross, Ga.). The fines were at 28.7% solids.

The fine fraction was dosed with 0.5 lb./ton of Colloid 211 (Rhone Poulenc, Marietta, Ga.) (sodium polyacrylate) on an as received basis followed by adding 2.5 lbs./ton of Nalco 9868 as a 5% active reagent. After mixing for approximately 2 h, the slip was conditioned through a Kady mill consuming from 38 to 57 HP-hours/ton. The conditioned slip was processed through a high gradient magnetic separator filled with a nominal matrix (60 μm in diameter). The slip was retained in the magnet matrix for 3 minutes and the magnet cycle had a duration of 12 minutes. The fines were then treated with sulfuric acid to lower the pH to 2.8, dosed with 4 lbs./ton of sodium dithionite and then filtered. The filter cake was reblunged with soda ash and sodium polyacrylate to a pH=6.2 and then spray dried.

Table I summarizes the properties of the magnetically separated hydrous kaolin used to prepare the metakaolin samples.

TABLE I

| Property | Value |
|---|---|
| Brightness¹ | 91.0 |
| L¹ | 96.1 |
| a¹ | −0.3 |
| b¹ | 2.2 |
| Particle size² | |
| % < 2 μm | 91.3 |
| % < 1 μm | 79.7 |

¹Technibrite TB-1C
²Sedigraph 5100

### Example 2

This Example describes the preparation of the inventive metakaolins and compostions comprising these metakaolins. The optical properties of the inventive metakaolins and metakaolin compositions were measured and compared with those of prior art, commercially available samples A-D.

The magnetically separated kaolin of Example 1 was calcined at 850° C. for 1 h to generate the inventive metakaolin. Tables II and III list the optical properties of the dry and wet metakaolin samples, respectively, as compared to the commercially available metakaolin counterparts.

TABLE II
Summary of Optical Properties - Dry Pigment
Metakaolin Sample Comparison

| Property | Inventive Metakaolin | A | B | C | D |
|---|---|---|---|---|---|
| L¹ | 97.3 | 96.1 | 95.6 | 95.8 | 95.4 |
| a¹ | −0.6 | −0.5 | −0.6 | −0.3 | −0.4 |
| b¹ | 3.3 | 5.1 | 5.6 | 4.8 | 5.4 |
| Brightness¹ | 91.8 | 87.1 | 85.5 | 87.0 | 85.4 |
| Particle size² | | | | | |
| % < 2 μm | 86.8 | | | | |
| % < 1 μm | 68.2 | | | | |

¹Technibrite TB-1C
²Sedigraph 5100

TABLE III
Summary of Optical Properties - Wet Pigment
Metakaolin Sample Comparison

| | This | | | | |
|---|---|---|---|---|---|
| Property | Invention² | A² | B² | C² | D² |
| L¹ | 86.3 | 84.7 | 84.0 | 83.8 | 83.7 |
| a¹ | −0.1 | 0.7 | 0.4 | 1.0 | 0.7 |
| b¹ | 7.6 | 9.1 | 10.0 | 9.1 | 9.3 |

¹Hunter UltraScan XE
²Aqueous Paste - 40% solids

Components a, b, and L are the color component values on the color space scale as measured by either a Technibrite TB-1C instrument (Table II) or a Hunter Ultrascan XE instrument (Table III). “+a” is a measure of red tint; “−a” is a measure of green tint; “+b” is a measure of yellow tint; “−b” is a measure of blue tint; “L” is a measure of whiteness.

A metakaolin-containing plaster sample was also prepared by combining the inventive metakaolin described in Table II with commercial Type I white Portland cement in a 25:75 ratio. Wet and dry samples were subject to a 30-day curing process at ambient temperature. Table IV lists the optical properties of these cured wet and dry samples compared to plasters prepared from commercially available samples A and B, which were also subjected to the same 30-day curing process.

TABLE IV
Summary of Optical Properties
Metakaolin-Containing Plaster¹ Sample Comparison

| | | | |
|---|---|---|---|
| | Inventive | | |
| | Metakaolin | | |
| Property | of Table II⁵ | A⁶ | B⁷ |

| | | | | |
|---|---|---|---|---|
| L² | 30 Day³ | 92.0 | 89.0 | 89.4 |
| | Dry⁴ | 93.3 | 90.0 | 90.7 |
| a² | 30 Day³ | −0.7 | −0.2 | −0.2 |
| | Dry⁴ | −0.4 | −0.2 | −0.2 |
| b² | 30 Day³ | 4.2 | 6.3 | 6.1 |
| | Dry⁴ | 4.2 | 5.9 | 5.9 |

¹MK/Cement = 25/75
²Hunter UltraScan XE
³30-day cure, wet
⁴30-day cure, dry
⁵Water/Cement = 0.80
⁶Water/Cement = 0.65
⁷Water/Cement = 0.65

### Example 3

In this Example, the optical properties of a paint comprising the inventive metakaolin of Example 2 are compared with the properties of a paint containing a commercially available metakaolin.

Table V lists the pigment and latex components of a 63% PVC formulation containing the inventive metakaolin and the commercially available kaolin. TiO₂ is commercially available as a number of different products, such as R-706. The latex can be any type of latex typically used in paint formulations, such as the latex commercially available as Ucar 379.

TABLE V
Pigment Formulation Summary - 63% PVC
Pounds per 100 Gallons of Paint

| | Inventive | |
|---|---|---|
| | Metakaolin of Table | Commercial |
| Formulation | II | Metakaolin |
| TiO₂ | 72.6 | 72.6 |
| Diatomaceous Earth | 47.8 | 47.8 |
| Calcium Carbonate “A” | 73.4 | 73.4 |
| Calcium Carbonate “B” | 132.2 | 132.2 |
| Inventive Metakaolin of | 201.9 | — |
| Table II | | |
| Commercial Metakaolin | — | 201.9 |
| Latex | 213.5 | 213.5 |

Table VI summarizes the dry paint film properties of the 63% PVC formulation.

TABLE VI
Summary of Paint Film¹ Properties,- 63% PVC

| | Inventive Metakaolin of | Commercial |
|---|---|---|
| Formulation² | Table II | Metakaolin |
| 60° Gloss³ | 3.0 | 2.9 |
| 85° Sheen³ | 5.2 | 3.1 |
| L⁴ | 95.8 | 95.0 |
| a⁴ | −0.7 | −0.7 |
| b⁴ | 2.3 | 3.3 |
| ASTM-E-313 White⁴ | 79.9 | 72.6 |
| ASTM-E-313 Yellow⁴ | 3.3 | 4.9 |
| Brightness⁴ | 89.2 | 86.2 |
| Opacity | 97.8 | 97.6 |
| Weight Solids | 59.9% | 59.9% |
| Volume Solids | 40.2% | 40.2% |

¹3-mil wet film drawdown
²Pounds per 100 gallons
³Hunter Pro-3 Gloss Meter
⁴Hunter UltraScan XE

Gloss and sheen were measured in a known manner using a Hunter Pro-3 Gloss Meter. ASTM-E-313 white and yellow are standard measurements, made using a Hunter Ultrascan XE Instrument, of the whiteness and yellowness of near white, opaque film coatings.

It can be seen from Table VI that the paint films obtained from formulations prepared from the inventive metakaolin pigments provided superior whiteness and brightness properties compared to the paint containing the commercially available metakaolin.

Tinted films were made from the 63% PVC paint by adding the equivalent of 11 pounds by weight of Phthalo Blue dispersion to 100 gallons of paint. Table VII summarizes the properties of the dry tinted paint films from the 63% PVC formulations.

TABLE VII
Summary of Blue Tint¹ Paint Film Properties - 63% PVC

| | Inventive Metakaolin of | Commercial |
|---|---|---|
| Formulation² | Table II | Metakaolin |
| L³ | 81.9 | 80.6 |
| a³ | 10.9 | 11.5 |
| b³ | 14.3 | 14.1 |
| ΔL | — | 1.3 |
| Δa | — | 0.6 |
| Δb | — | 0.2 |
| ΔE | — | 1.4 |

¹11 pounds Phthalo Blue dispersion per 100 gallons
²Pounds per 100 gallons
³Hunter UltraScan XE

The parameter ΔE is a measure of tint strength and is given by the expression: ΔE=(ΔL²+Δa²+Δb²)^{1/2}. From Table VII, it can be seen that the inventive metakaolin show superior overall tint strength.

### Example 4

This Example describes the preparation of fully calcined kaolin. The optical properties of this inventive sample were measured and compared with those of a commercially available very-high whiteness, fully calcined kaolin.

The magnetically separated hydrous kaolin of Example 1 was calcined at 1050° C. for 1 h to generate the fully calcined kaolin sample. Table VIII lists the optical properties of the dry fully calcined kaolin and the commercially available kaolin. As can be seen from Table VIII, the inventive method creates a calcined kaolin of high whiteness comparable to a commercially available control.

TABLE VIII
Physical Property Summary

| Sample | Inventive calcined kaolin | Commercial Product |
|---|---|---|
| L¹ | 97.9 | 97.9 |
| a¹ | −0.7 | −0.5 |
| b¹ | 1.8 | 1.3 |
| Brightness¹ | 95.1 | 95.7 |
| Oil Absorption² | 96 | 100 |
| Particle size³ | | |
| % < 2 μm | 85 | 74 |
| % < 1 μm | 56 | 36 |

¹Technibrite TB-1C
²ASTM-D-281 Rubout Method
³Sedigraph 5100

### Example 5

In this Example, paints containing the inventive fully calcined kaolin of Example 4 were prepared. The optical properties of these paints were measured and compared with those of paints comprising commercially available, high whiteness, fully calcined kaolin.

Table IX lists the pigment and latex components of a 44% PVC formulation containing the inventive fully calcined kaolin of Example 4 and the commercially available high-whiteness calcined kaolin.

TABLE IX
44% PVC Pigment Formulation Summary
Pounds per 100 Gallons of Paint

| | Inventive Calcined Kaolin | |
|---|---|---|
| Formulation | of Table VIII | Commercial Product |
| TiO₂ | 102.3 | 102.3 |
| Calcium Carbonate | 72.2 | 72.2 |
| Inventive Kaolin | 199.5 | — |
| Commercial Product | — | 199.5 |
| Latex | 338.6 | 338.6 |

Table X summarizes the dry paint film properties of the 44% PVC formulation.

TABLE X
Summary of Paint Film¹ Properties - 44% PVC

| | Inventive Calcined Kaolin | |
|---|---|---|
| Formulation² | of Table VIII | Commercial Product |
| 60° Gloss³ | 3.0 | 3.0 |
| 85° Sheen³ | 8.1 | 4.9 |
| L⁴ | 95.9 | 95.9 |
| a⁴ | −1.0 | −0.9 |
| b⁴ | 1.0 | 0.8 |
| ASTM-E-313 White⁴ | 87.7 | 88.8 |
| ASTM-E-313 Yellow⁴ | 1.2 | 0.9 |
| Brightness⁴ | 91.1 | 91.3 |
| Opacity | 96.2 | 96.1 |

¹3-mil wet film drawdown
²Pounds per 100 gallons
³Hunter Pro-3 Gloss Meter
⁴Hunter UltraScan XE

It can be seen from Table X that the paint films obtained from formulations prepared from the inventive fully calcined kaolins provided comparable whiteness and brightness properties compared to the paint containing the high-whiteness commercially available product.

Tinted films were made from the 44% PVC paint by adding the equivalent of 11 pounds by weight of Phthalo Blue dispersion to 100 gallons of paint. Table XI summarizes the properties of the tinted dry paint films from the 44% PVC formulations.

TABLE XI
Summary of Blue Tint¹ Paint Film Properties - 44% PVC

| | Inventive Calcined Kaolin of | |
|---|---|---|
| Formulation² | Table VIII | Commercial Product |
| L³ | 79.8 | 79.6 |
| a³ | −12.2 | −12.4 |
| b³ | −17.1 | −18.1 |
| ΔL | — | 0.2 |
| Δa | — | 0.2 |
| Δb | — | 0.4 |
| ΔE | — | 0.5 |

¹11 pounds Phthalo Blue dispersion per 100 gallons
²Pounds per 100 gallons
³Hunter UltraScan XE

Table XII lists the pigment and latex components of a 55% PVC formulation containing the inventive fully calcined kaolin of Example 4. Tables XII and XIV summarize the dry paint film and dry tinted film properties of the 55% PVC formulation, respectively.

TABLE XII
55% PVC Pigment Formulation Summary
Pounds per 100 Gallons of Paint

| | Inventive Calcined Kaolin | |
|---|---|---|
| Formulation | of Table VIII | Commercial Product |
| TiO₂ | 81.0 | 81.0 |
| Calcium Carbonate | 129.8 | 129.8 |
| Inventive calcined | 144.9 | — |
| kaolin | | |
| Commercial Product | — | 144.9 |
| Latex | 249.9 | 249.9 |

TABLE XIII
Summary of Paint Film¹ Properties - 55% PVC

| | Inventive calcined kaolin of | |
|---|---|---|
| Formulation² | Table VIII | Commercial Product |
| 60° Gloss³ | 2.9 | 3.0 |
| 85° Sheen³ | 3.7 | 3.4 |
| L⁴ | 95.7 | 95.7 |
| a⁴ | -0.9 | -0.9 |
| b⁴ | 1.4 | 1.3 |
| ASTM-E-313 White⁴ | 85.0 | 85.6 |
| ASTM-E-313 Yellow⁴ | 1.8 | 1.6 |
| Brightness⁴ | 90.2 | 90.2 |
| Opacity | 95.9 | 95.9 |

¹3-mil wet film drawdown
²Pounds per 100 gallons
³Hunter Pro-3 Gloss Meter
⁴Hunter UltraScan XE

TABLE XIV
Summary of Blue Tint¹ Paint Film Properties - 55% PVC

| | Inventive Calcined Kaolin of | |
|---|---|---|
| Formulation | Table VIII | Commercial Product |
| L | 79.6 | 79.2 |
| a | −12.3 | −12.5 |
| b | −17.5 | −18.0 |
| ΔL | — | 0.4 |
| Δa | — | 0.2 |
| Δb | — | 0.5 |
| ΔE | — | 0.7 |

¹11 pounds Phthalo Blue dispersion per 100 gallons
²Pounds per 100 gallons
³Hunter UltraScan XE

Table XV lists the pigment and latex components of a 65% PVC formulation containing the inventive fully calcined kaolin of Example 4. Tables XVI and XVII summarize the dry paint film and dry tinted film properties of the 65% PVC formulation, respectively.

TABLE XV
65% Pigment Formulation Summary
Pounds per 100 Gallons of Paint

| | Inventive Calcined Kaolin | |
|---|---|---|
| Formulation | of Table VIII | Commercial Product |
| TiO₂ | 58.8 | 58.8 |
| Calcium Carbonate | 264.3 | 264.3 |
| Inventive calcined | 148.4 | — |
| kaolin | | |
| Commercial Product | — | 148.4 |
| Latex | 213.5 | 213.5 |

TABLE XVI
Summary of Paint Film¹ Properties - 65% PVC

| | Inventive Calcined Kaolin | |
|---|---|---|
| Formulation² | of Table VIII | Commercial Product |
| 60° Gloss³ | 2.9 | 3.0 |
| 85° Sheen³ | 3.8 | 4.0 |
| L⁴ | 95.5 | 95.4 |
| a⁴ | −0.8 | −0.8 |
| b⁴ | 1.6 | 1.4 |
| ASTM-E-313 White⁴ | 83.4 | 84.0 |
| ASTM-E-313 Yellow⁴ | 2.1 | 2.0 |
| Brightness⁴ | 89.4 | 89.5 |
| Opacity | 96.8 | 96.1 |

¹3-mil wet film drawdown
²Pounds per 100 gallons
³Hunter Pro-3 Gloss Meter
⁴Hunter UltraScan XE

TABLE XVII
Summary of Blue Tint¹ Paint Film Properties - 65% PVC

| | Inventive Calcined Kaolin of | |
|---|---|---|
| Formulation² | Table VIII | Commercial Product |
| L³ | 79.3 | 78.8 |
| a³ | −12.3 | −12.4 |
| b³ | −17.4 | −17.8 |
| ΔL | — | 0.6 |
| Δa | — | 0.5 |
| Δb | — | 0.1 |
| ΔE | — | 0.4 |

¹11 pounds Phthalo Blue dispersion per 100 gallons
²Pounds per 100 gallons
³Hunter UltraScan XE

Table XVIII lists the pigment and latex components of a 75% PVC formulation containing the inventive fully calcined kaolin of Example 4. Tables XIX and XX summarize the dry paint film and dry tinted film properties of the 75% PVC formulation, respectively.

TABLE XVIII
75% PVC Pigment Formulation
Pounds per 100 Gallons of Paint

| | Inventive Calcined Kaolin | |
|---|---|---|
| Formulation | of Table VIII | Commercial Product |
| TiO₂ | 68.5 | 68.5 |
| Calcium Carbonate | 281.8 | 281.8 |
| Inventive calcined | 244.8 | — |
| kaolin | | |
| Commercial Product | — | 244.8 |
| Latex | 146.9 | 146.9 |

TABLE XIX
Summary of Paint Film¹ Properties - 75% PVC

| | Inventive Calcined Kaolin | |
|---|---|---|
| Formulation² | of Table VIII | Commercial Product |
| 60° Gloss³ | 3.2 | 3.1 |
| 85° Sheen³ | 10.8 | 6.7 |
| L⁴ | 96.5 | 96.3 |
| a⁴ | −0.8 | −0.8 |
| b⁴ | 1.1 | 0.9 |
| ASTM-E-313 White⁴ | 88.1 | 88.6 |
| ASTM-E-313 Yellow⁴ | 1.3 | 1.1 |
| Brightness⁴ | 92 | 91.9 |
| Opacity | 98.1 | 98.0 |

¹3-mil wet film drawdown
²Pounds per 100 gallons
³Hunter Pro-3 Gloss Meter
⁴Hunter UltraScan XE

TABLE XX
Summary of Blue Tint¹ Paint Film Properties - 75% PVC

| | Inventive Calcined Kaolin of | |
|---|---|---|
| Formulation² | Table VIII | Commercial Product |
| L³ | 82.8 | 82.1 |
| a³ | −10.6 | −10.8 |
| b³ | −14.6 | −15.4 |
| ΔL | — | 0.7 |
| Δa | — | 0.2 |
| Δb | — | 0.8 |
| ΔE | — | 1.1 |

¹11 pounds Phthalo Blue dispersion per 100 gallons
²Pounds per 100 gallons
³Hunter UltraScan XE

### Example 6

This Example describes the preparation of inventive metakaolins and fully calcined kaolins and their performance as fillers in a softwood/hardwood paper furnish.

Hydrous kaolin was subjected to enhanced magnetic separation according to Example 1. The properties of the hydrous fine particle kaolin are summarized in Table XXI.

TABLE XXI

| Property | Value |
|---|---|
| Brightness¹ | 90.2 |
| L¹ | 96.1 |
| a¹ | −0.6 |
| b¹ | 2.9 |
| Particle size² | |
| % < 2 μm | 97.7 |
| % < 1 μm | 90.3 |

¹Technibrite TB-1C
²Sedigraph 5100

Metakaolin was prepared by calcining the magnetically separated hydrous kaolin of Table XXI for 1 h at 800° C. Fully calcined kaolin was prepared by calcining the magnetically separated hydrous kaolin of Table XXI for 1 h at 1050° C. The properties of the inventive metakaolin and fully calcined kaolin are summarized in Table XXII.

TABLE XXII

| | | Inventive Fully |
|---|---|---|
| Property | Inventive Metakaolin | Calcined Kaolin |
| Brightness¹ | 88.8 | 94.9 |
| L¹ | 96.7 | 97.9 |
| a¹ | −0.6 | −0.8 |
| b¹ | 4.7 | 2.1 |
| Particle size² | | |
| % < 2 μm | 90.5 | 87.1 |
| % < 1 μm | 74.9 | 66.2 |

¹Technibrite TB-1C
²Sedigraph 5100

The inventive metakaolin and fully calcined kaolins described in Table XXII were evaluated as 45% softwood/55% hardwood furnishes, respectively. Accordingly, samples were prepared containing these kaolins as fillers in amounts ranging from 5-15% by final paper weight. The filler retention and optical properties of the resulting handsheets were measured and compared with those coated with furnishes containing commercially available metakaolin and fully calcined kaolin, respectively. Table XXIII summarizes the filler retention and optical properties of the resulting handsheets (optical properties measured via Technibrite TB-1C).

TABLE XXIII
Summary of Furnished Handsheet Properties

| | Opacity | | Brightness | | Retention |
|---|---|---|---|---|---|
| Pigment | 5.0%¹ | 10.0% | 5.0% | 10.0% | (%) |
| Inventive | 78.0 | 82.9 | 85.8 | 87.5 | 65 |
| Metakaolin | | | | | |
| Inventive Fully | 78.0 | 83.0 | 86.5 | 88.9 | 69 |
| Calcined Kaolin | | | | | |
| Commercial | 78.0 | 83.2 | 83.6 | 83.6 | 64 |
| Metakaolin | | | | | |
| Commercial Fully | 78.5 | 83.7 | 86.3 | 88.6 | 66 |
| Calcined Kaolin | | | | | |

¹Denotes filler level present in sheet

From Table XXIII, it can be seen that the handsheets prepared from the furnishes containing the inventive calcined fillers display superior brightness properties while maintaining comparable opacity and retention properties to those furnishes from commercially available calcined kaolins.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

What is claimed is:

1. A method of making a calcined kaolin, comprising:
(a) providing a hydrous kaolin;
(b) subjecting the hydrous kaolin to enhanced magnetic separation;
(c) heating the hydrous kaolin to a temperature ranging from about 500° C. to about 1200° C. for a time sufficient to at least partially dehydroxylate the hydrous kaolin; and
(d) obtaining a calcined kaolin having a whiteness defined by a Hunter lab coordinate L value of at least about 96.

2. The method according to claim 1, wherein the calcined kaolin in (d) has a brightness of at least about 90, as measured by a Technibrite TB-1C instrument.

3. The method according to claim 1, wherein the calcined kaolin in (d) has a brightness of at least about 91, as measured by a Technibrite TB-1C instrument.

4. The method according to claim 1, wherein the calcined kaolin in (d) has a Hunter lab coordinate L value of at least about 97.

5. The method according to claim 1, wherein the hydrous kaolin in (b) is present in an aqueous slurry.

6. The method according to claim 5, wherein the slurry comprises a magnet enhancer reagent.

7. The method according to claim 6, wherein the magnet enhancer reagent comprises at least one magnetic oxide chosen from metal oxides and mixed metal oxides.

8. The method according to claim 6, wherein the magnet enhancer reagent comprises a metal oxide coated with a surface active agent.

9. The method according to claim 6, wherein the magnet enhancer reagent comprises an iron oxide coated with a surface active agent.

10. The method according to claim 6, wherein the magnet enhancer reagent is shear-stable when subjected to a rotor device that can maintain a rotor blade tip speed of at least about 50 ft/s.

11. The method according to claim 8, wherein the surface active reagent is present in the magnet enhancer reagent in an amount of about 5% activity.

12. The method according to claim 1, wherein the hydrous kaolin is subjected to at least one beneficiation process prior to (c).

13. The method according to claim 12, wherein the at least one process is chosen from blunging, degritting, froth flotation, selective flocculation, and leaching.

14. The method according to claim 1, wherein the heating in (c) occurs for a time sufficient to fully dehydroxylate the hydrous kaolin.

15. The method according to claim 1, wherein the heating in (c) comprises flash calcining.

16. The method according to claim 1, wherein the heating in (c) comprises heating the hydrous kaolin at a temperature ranging from about 800° C. to about 1200° C.

17. The method according to claim 1, wherein the heating in (c) comprises heating the hydrous kaolin at a temperature ranging from about 800° C. to about 950° C.

18. The method according to claim 1, wherein the heating in (c) comprises heating the hydrous kaolin at a temperature ranging from about 900° C. to about 1200° C.

19. The method according to claim 1, wherein the heating in (c) comprises heating the hydrous kaolin at a temperature ranging from about 700° C. to about 900° C.

20. The method according to claim 1, wherein the heating in (c) comprises heating the hydrous kaolin at a temperature ranging from about 800° C. to about 850° C.

21. The method according to claim 1, wherein the heating in (c) comprises heating the hydrous kaolin at a temperature of at least about 900° C., and the calcined kaolin in (d) has a Hunter lab coordinate L value of at least about 97.5.

22. The method according to claim 1, wherein the heating in (c) comprises heating the hydrous kaolin at a temperature of at least about 900° C., and the calcined kaolin in (d) has a Hunter lab coordinate L value of at least about 98.

23. A calcined kaolin prepared by the process according to claim 1.

24. A composition comprising a kaolin calcined from an enhanced, magnetically separated hydrous kaolin, wherein the calcined kaolin, when dry, has a whiteness defined by a Hunter lab coordinate L value of at least about 96.

25. The composition according to claim 24, wherein the dry calcined kaolin has a brightness of at least about 90, as measured by a Technibrite TB-1C instrument.

26. The composition according to claim 25, wherein the dry calcined kaolin has a brightness of at least about 91, as measured by a Technibrite TB-1C instrument.

27. The composition according to claim 24, wherein the dry calcined kaolin has a whiteness defined by a Hunter lab coordinate L value of at least about 97

28. The composition according to claim 27, wherein the dry calcined kaolin has a brightness of at least about 91, as measured by a Technibrite TB-1C instrument.

29. The composition according to claim 24, wherein the kaolin comprises fully calcined kaolin.

30. The composition according to claim 24, wherein the kaolin comprises metakaolin.

31. The composition according to claim 24, wherein the kaolin comprises flash calcined kaolin.

32. A paint comprising the composition according to claim 24.

33. A polymer comprising the composition according to claim 24.

34. A ceramic comprising the composition according to claim 24.

35. A paper coating comprising the composition according to claim 24.

36. A paper coated with the paper coating according to claim 35.

37. A filler comprising the composition according to claim 24.

38. A filled paper comprising the filler according to claim 37.

39. A cementitious product coating comprising the composition according to claim 24.

40. A cementitious product coated with the coating according to claim 39.

41. A composition comprising a metakaolin having a whiteness defined by a Hunter lab coordinate L value of at least about 96.

42. The composition according to claim 41, wherein the metakaolin has a brightness of at least about 91, as measured by a Technibrite TB-1C instrument.

43. The composition according to claim 41, wherein the metakaolin has a whiteness defined by a Hunter lab coordinate L value of at least about 97

44. A paint comprising the composition according to claim 41.

45. A polymer comprising the composition according to claim 41.

46. A ceramic comprising the composition according to claim 41.

47. A paper coating comprising the composition according to claim 41.

48. A paper coated with the paper coating according to claim 47.

49. A filler comprising the composition according to claim 41.

50. A filled paper comprising the filler according to claim 49.

51. A cementitious product coating comprising the composition according to claim 41.

52. A cementitious product coated with the composition comprising the composition according to claim 51.
